(19) United States
(12) Patent Application Publication
(10) Pub. No.: US 2006/0225545 A1
(43) Pub. Date: Oct. 12, 2006

(54) Portable power tool for grooving pipes in the field

(76) Inventors: Lawrence J. Nolan, Livonia, MI (US); Jerry J. Jagodzinski, Farmington Hills, MI (US)

Correspondence Address: HARNESS, DICKEY & PIERCE, P.L.C., P.O. BOX 828, BLOOMFIELD HILLS, MI, 48303, US

(21) Appl. No.: 11/099,976

(22) Filed: Apr. 6, 2005

(51) Int. Cl. B27B 11/00; B26D 5/00

(52) U.S. Cl. 83/13; 83/743

(57) ABSTRACT

A manually operated, powered tool system, for forming coupling grooves in the ends of plastic pipes in the field comprises a track formed of hinged-together segments of a circle is tightly fitted around an exposed end of a pipe and a powered cutter mounted upon a guide which is manually moved around the track, cuts a groove in the pipe. The track is formed of a ring, sized to encircle and grip the pipe, and has a channel formed thereon. The guide has a portion engaged within the channel and an external portion carrying a powered cutter, so that the guide may be moved along the track, around the circumference of the pipe, for accurately locating the groove. To operate, and cut the groove, only a small end portion of the pipe need be exposed if the pipe is otherwise covered, such as by dirt, in the field and/or is connected, at its opposite end, to another pipe. Thus, the pipe need not be moved or uncovered when forming the groove.

### BACKGROUND OF THE INVENTION

This invention relates to a hand-operated, powered tool system for cutting coupling grooves in the ends of plastic pipes in the field without moving the pipes. Large diameter plastic pipes are commonly used in water supply systems and other liquid and gas transmission systems where the pipes are buried underground or are otherwise difficult to move. Commonly, such pipes are produced in sections which are coupled together end-to-end to form the required length of a pipeline.

A conventional form of pipe coupling comprises a ring which fits around the adjacent ends of a pair of aligned pipe sections to hold the ends together. Typically, such coupling rings have radially inwardly extending flanges formed at their opposite ends. These flanges fit into grooves that are cut into the pipes near their ends. In coupling a pair of pipes, their ends are aligned end-to-end. Then the coupling ring, which is typically formed of a pair of half-circular sections, is applied around the adjacent pipe ends. With the coupling ring encircling the pipe ends, the flanges are arranged in the pre-cut grooves that are formed in the pipe ends. Next, the two halves of the coupling are bolted together to connect the pipes. Hence, the grooves must be accurately located relative their pipe ends for a good connection.

Pipe sections are normally produced in standard lengths. Thus, the lengths of specific pipe sections may have to be varied, i.e. shortened, in order to fit within a particular place in a pipeline. Also, if an already installed pipe section end portion is damaged and that damaged portion has to be cut off and replaced, it may be desirable to cut off the damaged portion of the pipe section and replace it without removing the remaining part of the pipe from the pipeline or otherwise moving the pipe. Consequently, it is desirable, at such times, to form the coupling grooves in the pipe ends in the field without moving the pipe. For example, when a pipe is buried underground, and only its end portion is exposed, or the pipe is connected into a line of pipes, it may be difficult to uncover or to disconnect a pipe section from its location in order to take the section to a workplace where suitable machinery is available for accurately forming a coupling groove in its end. Similarly, it may be difficult or time-consuming to transport a replacement pipe section from the site where it is to be installed in order to form grooves in the section.

Hence, it is desirable to provide portable equipment which can accurately and quickly provide grooves in the end of a pipe in the field or construction site, without moving the pipe if the pipe is substantially covered or if it is attached in a pipeline to another pipe section.

Grooving equipment that is presently available, is generally large, unwieldy and difficult to use in the field. Hence, it would be desirable to provide equipment which is lightweight, easily transported and moved to, and usable in the field, as a hand-type tool, without moving or uncovering an entire pipe where an accurately located groove is needed on an end of the pipe for coupling purposes. Also, it is desirable that such a tool be self-powered and relatively inexpensive, as well as sufficiently compact to enable a workman to move and to use the tool without undue effort and without needing the assistance of a crane or other lifting equipment. The present invention is concerned with providing such a lightweight, portable, self-powered tool system which can be easily used by a workman to cut a coupling groove on the end portion of a pipe at an installation site, without requiring moving or uncovering the pipe.

Examples of prior grooving equipment are disclosed in U.S. Pat. No. 2,634,643, issued Apr. 14, 1953, to John A. Krooss for a “Pipe Grooving Tool,” and U.S. Pat. No. 3,699,828, issued Oct. 24, 1972, to Edward Walter Piatek, et al. for a “Pipe Groover.” Each of these patents disclose a relatively complex tool which is heavy and difficult and time-consuming to use in the field, and particularly, would be difficult to use to cut a pipe groove that is accurately positioned within a plane that is perpendicular to the axis of the tube. A conventional pipe coupling ring requires that the coupling grooves encircle the pipe and be arranged in a plane that is perpendicular to the axis of the pipe. It appears that it would be difficult, with the equipment disclosed in the above patents, to accomplish that arrangement automatically as is desirable.

### SUMMARY OF THE INVENTION

This invention contemplates the provision of a tool which includes a ring, that can be easily secured around the end portion of a pipe without exposing more than a minimal length of the pipe end for this purpose. The ring is formed with a channel which encircles the pipe. A cutting tool, such as a conventional router with a cutter bit, is mounted upon a carrier which has a channel guide portion that fits into the channel. Preferably, the carrier also has a pipe surface guide portion that is concave and is arranged to contact and slide along the curved outer surface of the pipe while the channel guide portion slides along the inside of the channel. Thus, the cutter bit is guided along a precise path for cutting a uniform depth, accurately located groove in the outer surface of the pipe.

It is necessary to locate the groove at a uniform distance relative to the free end of the pipe and within a plane that is perpendicular to the axis of the pipe in order to properly receive the corresponding flange of a coupling device. Hence, the cutter is guided, first, by the channel which forms a track that is arranged around the pipe in a plane that is perpendicular to the axis of the pipe and is located at a fixed distance from the pipe free end. In addition, the carrier uses the pipe surface as a guide, so as to precisely locate the groove and to enable the cutter to form a uniform depth groove. This is accomplished with equipment which is light in weight and easy to transport and to manually use in the field.

An object of this invention is to provide a lightweight, relatively inexpensive, easily used, powered tool which can precisely locate and cut a coupling channel in the peripheral surface of a pipe, such as a plastic pipe, rapidly, without having to move or uncover any more than a short length of the end of the pipe.

A further object is to provide equipment which can rapidly cut a coupling groove in the field, with minimal effort and time, without having to move the pipe to a fixed position machine or to a workshop or the like.

Still another object of this invention is to provide the pipe installation workmen with a means for rapidly and easily forming accurate coupling grooves in the ends of pipes at the installation site, in the field, which makes it possible for them to quickly install full pipe sections or portions of pipe sections, without necessarily moving the pipes or requiring the use of the commonly available large pipe grooving machinery that is remotely located from the installation site.

These and other objects of this invention will become apparent upon reading the following description, of which the attached drawings form a part.

### DESCRIPTION OF THE DRAWINGS

The present invention will become more fully understood from the detailed description and the accompanying drawings, wherein:

FIG. 1 illustrates, in perspective, the pipe grooving equipment arranged adjacent the end of a pipe, ready for installation upon the pipe, with the cutter separated from the carrier and the guide ring and channel.

FIG. 2 illustrates, in perspective, the guide ring and channel, or track, assembled upon the end portion of a pipe with the cutter guide being inserted in the track and mounted in position to begin the cutting operation.

FIG. 3 illustrates, in perspective, the cutter moved partially around the periphery of the pipe and illustrates the initial formation of the coupling groove.

FIG. 4 illustrates, in perspective, the completion of a groove cut in a pipe and the removal of the cutter device while the guide track is still in place on the pipe.

FIG. 5 illustrates, in perspective, the track secured upon the end portion of a pipe, and shows the opposite side of the tool and the pipe that is illustrated in FIG. 3.

FIG. 6 is an enlarged end view of the track and cutter mounted on a pipe end with the cutter moving around the pipe.

FIG. 7 is an enlarged, perspective, view of cutter carrier and guide adjacent the track and ready for installing in the track.

FIG. 8 is an enlarged, cross-sectional view of the end of the pipe with the guide track and the cutter and cutter carrier and guide shown in place.

FIG. 9 is a perspective view of the cutter carrier and guide block, per se.

FIG. 10 is a front end view of the cutter carrier and guide block as shown by arrows 10-10 of FIG. 9.

FIG. 11 is a rear end view of the cutter carrier and guide block taken in the direction of arrows 11-11 of FIG. 10.

FIG. 12 is a side view of the cutter carrier and guide block taken in the direction of arrows 12-12 of FIG. 10.

FIG. 13 is an end view, to a reduced scale, showing the track segments swung open for positioning the track around the end of a pipe.

FIG. 14 is a view similar to FIG. 13, illustrating the track segments swung into engagement with the exterior surface of the pipe.

### DETAILED DESCRIPTION OF THE PREFERRED EMBODIMENTS

The drawings illustrate a typical, large diameter plastic pipe 10 which is commonly used for a variety of purposes, as for example, for carrying water in underground installations. The pipes, for coupling purposes, are provided with grooves 11 near their ends (see FIGS. 4 and 8). These grooves serve to anchor or receive the flanges of conventional coupling rings which are used for attaching pipes end-to-end to form a line of pipes. The particular type of coupling device may vary as there are a number of different coupling device designs available on the market. However, each utilizes radially inwardly extending flanges which fit into grooves formed in the end portions of a pipe for anchoring or connecting the coupling device to a pipe. In general, such conventional coupling devices comprise a ring which encircles the adjacent ends of a pair of pipes with radially inwardly extending flanges formed on the opposite ends of the ring for connecting the coupling device to the aligned, adjacent ends of a pair of pipes. The coupling devices form no part of this invention as they are conventional.

A hand-operated power tool 15 is used for cutting a groove in the pipe. The power tool may be powered by batteries or by a connection to a conventional field type of electrical generator. Preferably, batteries would be utilized for this tool.

The tool includes a guide track 16 which encircles the end of the pipe. The guide track serves to position and guide a cutter support carrier 17, and a conventional router-type cutter device 18 or the like.

The track is formed of a pair of half-circle segments 20 and 21 which are hinged together by hinges 22 (see FIGS. 13 and 14). More segments may be utilized for a much larger pipe but for most conventional plastic pipes a pair of segments is sufficient.

The free ends of the segments are releasably connected together by a common toggle lock 24 formed on one of the segments and engaging a toggle clasp 25 formed on the other segment. Thus, the segments may be pivotally swung open to engage around a pipe and then swing closed to encircle and snuggly fit around and tightly grasp the pipe for positioning the track (see FIGS. 6, 13 and 14).

The track is formed with a ring 27 which closely engages the exterior surface of the pipe (see FIG. 8). The ring includes a guide channel 28. The channel is formed by a radially outwardly extending flange 29 that may be integral with the ring 27. An axially extending flange 30 is formed on the flange 29 and terminates in an outer, radially directed flange 31. Thus, the channel is defined by the first, radially outwardly extending flange 29, then the second, axially directed flange 30 and by the third, outer radially arranged flange 31. The axially directed flange 30 is provided with an opening 32 along its surface which provides the entrance for the guide member into the channel 28, as described below.

The cutter support and guide includes a guide block 35 which enters into the channel 28 through the channel opening 32. The guide block 35 slides around the channel and traverses the circumference of the pipe. It is connected to the support block 41 whose lower surface 43 is curved to closely match the curvature of the surface of the pipe. A guide groove 44 is formed between the guide block 35 and the support block 41. Thus, it receives the free end of the outer radial flange 31. The guide block 35 has its upper surface 45 curved to match the curvature of the axially directed flange 30 of the channel.

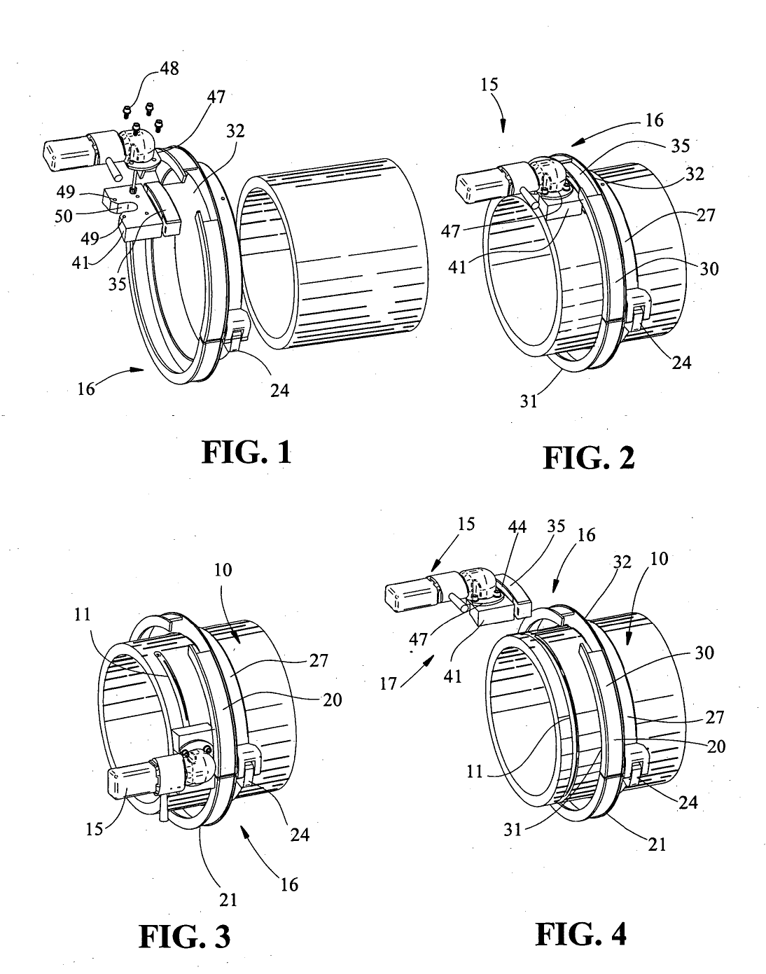

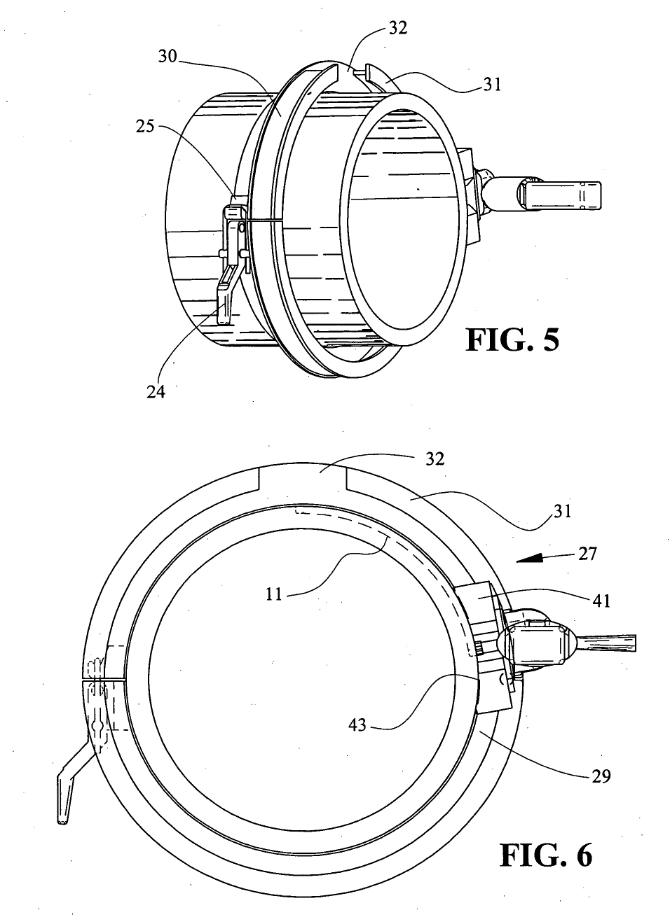

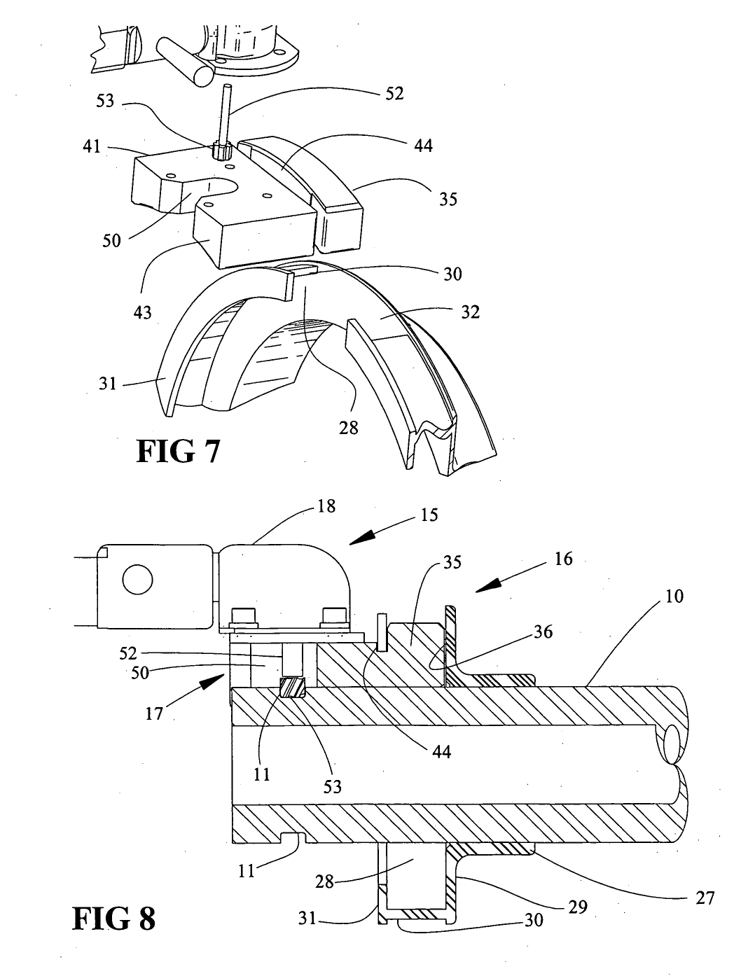

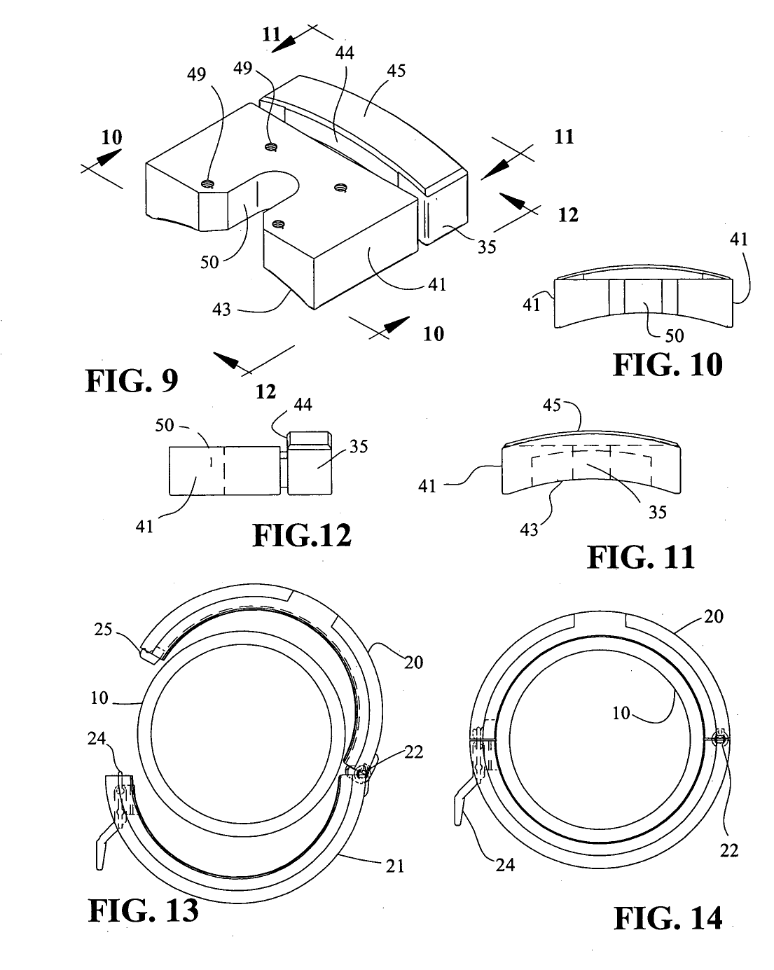

A plate 47 is positioned on the upper surface of the support block 41 and fastened thereto by screws 48 (see FIG. 1) engaging through screw holes 49.

The hand-operated, power cutter tool 15 is attached to the plate 47. That tool may be a conventional router, which preferably is battery-powered, as mentioned above.

A slot 50 is formed in the support block 41. Thus, a shaft 52 extends downwardly from the router through the slot to the surface of the pipe. At the end of the shaft, a conventional cutter bit 53 is mounted for extending into and cutting the groove. The router tool can be any conventional, commercially available router or similar tool which has a cutter mechanism usable for this purpose.

The circular tracks may be formed in several pre-determined sizes which have curvatures to match commonly used size pipes. Thus, a workman might need one, two, three or four tracks for a job along with correspondingly sized cutter support and guide blocks to fit each of these tracks. Since, typical pipe systems utilize numerous pipes of the same diameters, additional guide blocks and carriers may not be needed.

Significantly, the grooving tool is simple in construction, is lightweight, and is relatively inexpensive. The tool is particularly useful in grooving pipe ends in the field without having to move the pipes elsewhere. The tracks and guides are inexpensive so that a workman can be inexpensively supplied with the one or more sizes needed for a particular pipeline and can carry a small number of extra sizes, if needed.

The particular size grooves that are cut are generally of a standard size when using commercially available coupling devices. Therefore, a single cutter with one or more appropriately sized cutter bits would be sufficient for all purposes in forming grooving in the field.

The foregoing describes a preferred embodiment of this invention. Thus, the specification should be read as being merely illustrative of an operative embodiment and not in a strictly limiting sense. Accordingly, we now claim:

What is claimed is:

1. A portable tool for forming a continuous, annular coupling groove in an exposed end portion of a plastic pipe in the field without moving or otherwise exposing the pipe, comprising:
a circular guide track formed of at least two segments, each having an internal circular edge portion of a diameter sized to closely fit around the surface of a pipe of pre-determined diameter;
a detachable fastener for fastening the segments together end-to-end to form a complete circle for engaging and encircling a pipe and temporarily securing the track upon the pipe;
a cutter mounted upon a carrier having a guide member which engaged and travels along the track for moving in a circular path around the perimeter of the pipe with the cutter engaging the surface of the pipe during the movement of the carrier member;
whereby a continuous groove is cut in the peripheral surface of the pipe along the track so that a pipe coupling may be engaged with the groove for securing the pipe end-to-end with another pipe, regardless as to whether the pipe is otherwise immovably covered or has its opposite end connected to another pipe.

2. A portable power tool for forming a continuous groove on an exposed end portion of a pipe as defined in claim 1, and including
said track having a ring portion for engaging the surface of, and encircling the pipe in contact with the pipe, and having a channel formed on the ring portion and extending around the pipe when the track is mounted upon a pipe;
said guide member having a guide block fitted within said channel for guiding movement of the guide block along the channel;
a carrier member secured to, and moveable with, and guided around the pipe by, the guide block, and having a curved inner surface shaped to engage the surface of the pipe as it moves around the pipe, and having an outer surface;
a powered cutter hand tool secured upon said outer surface and powering a cutter bit located radially inwardly of said carrier inner surface for engaging and cutting a groove in the surface of the pipe as the carrier member moves around the circumference of the pipe;
whereby an annular groove may be cut in the pipe and be accurately located near the end of a pipe for attachment of a pipe couple.

3. A portable power tool for forming a continuous groove on an exposed end of a pipe as defined in claim 1, and including said channel being formed by a radially outwardly extending first flange formed on said ring, and an axially extending second flange formed on said first flange at a radially outward distance relative to the ring, and with a third, radially extending flange formed on the second flange to provide a channel defined by the flanges;
and said guide block being positioned within said channel in engagement with the adjacent portions of the flanges and with the surface of the pipe for accurately guiding the guide block as it moves along the track.

4. A portable power tool for forming a continuous groove on an exposed end portion of a pipe as defined in claim 3, and said guide block having an inner surface shaped to contact the outer surface of the pipe, surface-to-surface, as the guide block moves along the channel.

5. A portable power tool for forming a continuous groove on an exposed end portion of a pipe as defined in claim 4, and said carrier having a radially directed surface engaging said third flange, outwardly of said channel, as the carrier moves along the track, whereby the carrier is guided by the guide block and by the carrier's engagement with the third flange and, also, with the engagement with the surface of the pipe, to accurately position the cutter bit as it cuts the groove and thereby to accurately locate the groove at a pre-determined location along the end portion of the pipe and within a plane normal to the axis of the pipe.

6. A portable power tool for forming a continuous groove on an exposed end portion of a pipe as defined in claim 5, and including an opening formed in the second flange through which the guide block is inserted for fitting into the channel and for thereby moving within the channel, and conversely, for enabling removal of the cutter block from the channel after a groove is cut by the tool.

7. A method for cutting a continuous annular groove around the periphery of a plastic pipe near an exposed end of the pipe when in the field, which pipe may be substantially covered or which may have its opposite end connected to a second pipe, without the need to move or uncover the pipe, comprising:
exposing a short length of the portion of the plastic pipe into which a groove is to be formed;
temporarily encircling and securing to the pipe adjacent its exposed end portion, a guide track which has an inner curved surface shaped to tightly engage the surface of the plastic pipe;
engaging the guide track with a connector member which is moveable along the track to traverse the circumference of the plastic pipe;
pre-mounting a cutter element on the connector member for engaging and cutting a groove around the pipe end as the connector traverses the circumference of the pipe;
manually moving the connector member, guided by the track, around the pipe for cutting the groove therein;
removing the connector member and the track after the groove is completed;
whereby an annular groove for use in connecting a pipe coupling is formed in the circumference of the exposed portion of the plastic pipe.

8. A method for cutting a continuous annular groove around the periphery of a plastic pipe, as defined in claim 7, and including providing an annular channel on said track to encircle the pipe;
positioning a guide member in the channel with a cutter carrier member secured to the guide member, and with the cutter member having a surface shaped to closely engage the surface of the pipe; and a powered cutter mounted upon the cutter carrier member for engaging the wall of the pipe and cutting the groove therein;
manually moving the guide member, with the carrier, along the channel for guiding the cutter as it cuts the groove in the surface of the pipe for accurately locating the cut groove relative to the pipe end and within a plane normal to the axis of the pipe.

9. A method as defined in claim 8, and forming the track in segments of a circle with the segments hingedly connected together end-to-end to form a complete circle;
applying the track upon the pipe end by hingedly swinging the segments apart, positioning the segments around the pipe end portion, and thereafter hingedly swinging the segments together to encircle and tightly engage the pipe;
whereby the track and its channel are arranged in a plane that is perpendicular to the axis of the pipe and the track may be temporarily applied upon the pipe and removed therefrom for cutting the groove in the pipe.
